(19) United States
(12) Patent Application Publication
(10) Pub. No.: US 2007/0035250 A1
(43) Pub. Date: Feb. 15, 2007

(54) Ceramic arc tube and end plugs therefor and methods of making the same

(76) Inventors: Stuart Albert Mucklejohn, Wigston Magna (GB); Andrew Davies, Hinkley (GB); Ishmail Laher, Oadby (GB); Keith Parker, Burrough-On-The-Hill (GB)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 11/499,151

(22) Filed: Aug. 4, 2006

(30) Foreign Application Priority Data
Aug. 5, 2005 (GB) 0516198.9

(51) Int. Cl. H01J 17/18

(52) U.S. Cl. 313/625

(57) ABSTRACT

A one piece end plug (120, 124) for use in a three part ceramic arc tube comprises a cylindrical head portion of a diameter suitable for insertion into a cylindrical body portion and a circular leg portion formed on the head portion so as to be coaxial therewith and tapering inwardly from the head portion outwards, the whole having a through aperture for receipt of electrodes and being formed of single ceramic pressing.

### BACKGROUND OF THE INVENTION

This invention relates to a ceramic arc tube and end plugs therefor and to methods of making the same.

The present invention relates to a ceramic arc chamber for a discharge lamp, such as a ceramic metal halide lamp. In particular, this invention relates to a method of manufacturing ceramic arc chambers, and more particularly, to a method for forming ceramic arc chambers.

Discharge lamps produce light by ionising a fill such as a mixture of metal halides and mercury by passing an electric arc between two electrodes. The electrodes and the fill are sealed within a translucent or transparent discharge chamber which maintains the pressure of the energised fill material and allows the light emitted thereby to pass through it. The fill, also known as a “dose”, emits a desired spectral energy distribution in response to being excited by the electric arc.

Previously, the discharge chamber in a discharge lamp was formed from a vitreous material such as fused quartz, which was shaped into a desired chamber geometry after being heated to a softened state. Fused quartz, however, has certain disadvantages which arise from its reactive properties at high operating temperatures. For example, at temperatures greater than about 950 to 1000° C., the halide fill reacts with the glass to produce silicates and silicon halides, reducing the fill constituents. Elevated temperatures also cause sodium to permeate through the quartz wall. These fill depletions cause color shift over time, which reduces the useful life of the lamp.

Ceramic discharge chambers were developed to operate at high temperatures for improved color temperatures, color renderings, and luminous efficacies, while significantly reducing reactions with the fill material. U.S. Pat. Nos. 4,285,732 and 5,725,827, for example, disclose translucent polycrystalline sintered bodies where visible wavelength radiation is sufficiently able to pass through to make the body useful for use as an arc tube.

Typically, ceramic discharge chambers are constructed from a number of parts extruded or die pressed from a ceramic powder and then sintered together. For example, referring now to European Patent Application No. 0587238, five ceramic parts are used to construct the discharge chamber of a metal halide lamp. Two end plugs with a central bore are fabricated by die pressing a mixture of a ceramic powder and inorganic binder. A central cylinder and the two legs are produced by extruding a ceramic powder/binder mixture through a die. After forming the part, it is typically air sintered between 900-1400° C. to remove organic processing aids. Assembly of the discharge chamber requires tacking of the legs to the cylinder plugs, and the end plugs into the end of the central cylinder. This assembly is then sintered to form joints which are bonded by controlled shrinkage of the individual parts. Obviously, a simplified form of the product would be achieved by the reduction in the number of components separately formed. Moreover, the step of properly joining the compounds is time consuming, expensive and a potential point of failure.

For example, the number of component parts is relatively large and introduces the corresponding number of opportunities for variation and defects. Also, the conventional discharge chamber includes four bonding regions, each of which introduces an opportunity for lamp failure by leakage of the fill material if the bond is formed improperly. Each bonding area also introduces a region of relative weakness, so that even if the bond is formed properly, the bond may break during handling or be damaged enough in handling to induce failure in operation.

Another disadvantage relates to the precision with which the parts can be assembled and the resulting effect in the light quality. It is known that the light quality is dependent to a substantial extent on the voltage across the electrode gap, which in turn is dependent on the size of the gap consistently achieve the gap size within an acceptable tolerance without significant effort devoted to optimising the manufacturing process. Accordingly, it would be desirable to minimise the component parts necessary to manufacture the ceramic arc chamber. However, divergent shrinkage rates of variously shaped components and other factors have limited the ability to manufacture in a more efficient manner.

A first attempt to deal with theses problems is described in U.S. Pat. No. 6,679,961. In this Patent, an arc chamber is formed of three parts, a central body member and two leg portions, one of which fits into an opposite end of the central body member and, to this end, is provided with a transition portion which fits into the central body member. This transition portion has a flange which is of the same diameter as the external diameter of the body member and thus forms a shoulder which sits against the end of the body member and locates the leg portion in relation to the body member. The leg portions are initially formed by die pressing to the appropriate external shape and then, having thereafter been heat treated to remove binder from the pressed member, are machined to provide a through bore to take the electrode and its lead in wire.

Additionally, it has been found that the accuracy of the pressings described in this US Patent is insufficient for accurate assembly and extensive machining is necessary before the parts can be assembled into a suitable arc chamber.

The present invention seeks to provide an arc chamber in which the leg parts can be made by pressing and which do not require machining before assembly to the main body portion of the chamber.

According to the invention, a one piece end plug for use in a three part ceramic arc tube comprising a cylindrical head portion of a diameter suitable for insertion into a cylindrical body portion and a circular leg portion formed on the head portion so as to be coaxial therewith and tapering inwardly from the head portion outwards, the whole having a through aperture for receipt of electrodes and being formed of single ceramic pressing.

The end plug may be formed from approximately 95% by weight ceramic material and approximately 5% by weight organic additives. The ceramic material may be 99.99% Al₂O₃.

The ceramic material may have added to it a metal oxide such as MgO in the range of 100 to 1000 ppm.

The organic additives may comprise a mixture of monomeric and polymeric alcohols, carbonic acids and ethers.

The end plug may have a ratio of overall length to minimum leg outside diameter of 5.4 to 10.7, preferably 6.15 to 9.72

The end plug may have a ratio of overall length to plug outside diameter of 1.5 to 4.0, preferably 1.75 to 3.61.

The end plug may have a ratio of plug diameter to minimum leg diameter of 2.4 to 4.3, preferably 2.69 to 3.94.

The end plug may have a ratio of leg length to plug length of 3.8 to 8.3, preferably 4.25 to 7.5.

The end plug may have a ratio of leg length to overall diameter of 0.7 to 1.0, preferably 0.81 to 0.88.

The end plug may have a leg aspect ratio of 3.5 to 7.3, preferably 3.90 to 6.66.

The end plug may have a plug aspect ratio of 0.2 to 0.5, preferably 0.22 to 0.48.

The end plug may have a ratio of plug length to overall length of 0.1 to 0.2, preferably 0.12 to 0.19.

The end plug may have a ratio of minimum leg diameter to bore of 1.9 to 3.8, preferably 2.11 to 3.42.

The end plug may have a ratio of taper angle per side to degrees of 0.5 to 5.0, preferably 1.0 to 2.0

According to a second aspect of the invention, there is provided a method of making a one piece end plug for use in a three part ceramic arc tube comprising pressing a single blank to form a cylindrical head portion of a diameter suitable for insertion into a cylindrical body portion and a circular leg portion formed on the head portion so as to be coaxial therewith and tapering inwardly from the head portion outwards, the whole having a through aperture for receipt of electrodes.

The end plug may be formed from approximately 95% by weight ceramic material and approximately 5% by weight organic additives. The ceramic material may be 99.99% Al₂O₃.

The ceramic material may have added to it a metal oxide such as MgO in the range of 100 to 1000 ppm.

The organic additives may comprise a mixture of monomeric and polymeric alcohols, carbonic acids and ethers.

The end plug may have a ratio of overall length to minimum leg outside diameter of 5.4 to 10.7, preferably 6.15 to 9.72

The end plug may have a ratio of overall length to plug outside diameter of 1.5 to 4.0, preferably 1.75 to 3.61.

The end plug may have a ratio of plug diameter to minimum leg diameter of 2.4 to 4.3 preferably 2.69 to 3.94.

The end plug may have a ratio of leg length to plug length of 3.8 to 8.3 preferably 4.25 to 7.5.

The end plug may have a ratio of leg length to overall diameter of 0.7 to 1.0, preferably 0.81 to 0.88.

The end plug may have a leg aspect ratio of 3.5 to 7.3, preferably 3.90 to 6.66.

The end plug may have a plug aspect ratio of 0.2 to 0.5, preferably 0.22 to 0.48.

The end plug may have a ratio of plug length to overall length of 0.1 to 0.2, preferably 0.12 to 0.19.

The end plug may have a ratio of minimum leg diameter to bore of 1.9 to 3.8, preferably 2.11 to 3.42.

The end plug may have a ratio of taper angle per side to degrees of 0.5 to 5.0, preferably 1.0 to 2.0.

The invention also includes a three piece ceramic arc tube comprising a central cylindrical body portion and two end plugs as described above, one located at each end of the cylindrical body portion.

The invention further includes a method of making a three piece ceramic arc tube comprising forming a cylindrical body portion; forming a pair of end plugs as described above and attaching one end plug to each end of the cylindrical body portion.

### BRIEF DESCRIPTION OF THE DRAWINGS

The invention will now be described in greater detail, by way of example, with reference to the drawings, in which:

FIG. 1 shows a light bulb in which a ceramic arc tube in accordance with the invention is shown.

FIGS. 2 A, B and C show an exploded view of the parts of a ceramic arc chamber as shown in FIG. 1, the two end plugs being shown in FIGS. 2A and 2C while the main body is shown in FIG. 2B.

FIGS. 3 A, B and C show three views of the end plug for demonstrating the relative dimensions.

### DETAILED DESCRIPTION OF THE INVENTION

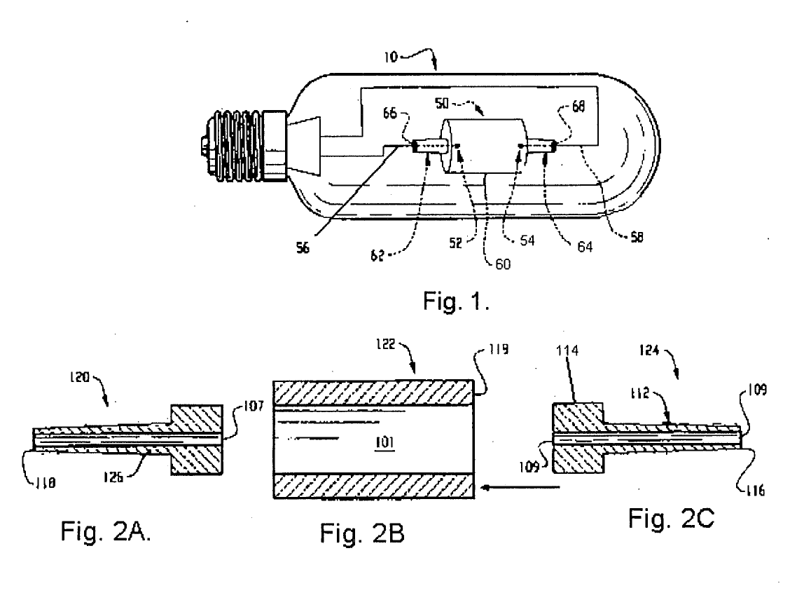

Referring firstly to FIG. 1, a discharge lamp 10 is shown having an arc discharge chamber 50 in accordance with the invention. The chamber 50 houses a pair of electrodes 52, 54 which are connected to conductors 56 and 58 which, in use, apply a potential across the electrodes 52, 54 so as to form an arc. This arc ionises a fill material in the discharge chamber 50 to produce a plasma.

The emission characteristics of the light produced by the plasma depend primarily on the constituents of the fill material, the voltage across the electrodes, the temperature distribution of the chamber, the pressure in the chamber, and the geometry of the chamber. For a ceramic metal halide lamp, the fill may typically comprise a mixture of Hg, a rare gas such as Ar or Xe and a combination of metal halides such as Nal, Tll and Dyl₃. For high pressure sodium lamp, the fill material typically comprises sodium, a rare gas, and Hg. Other fill materials are also well known in the art, and the present invention is believed to be suitable for operation with any of those recognised ionizable materials.

As shown in FIG. 1, the discharge chamber 50 comprises a central body portion 60 and two leg portions 62, 64. The ends of the electrodes 52, 54 are typically located near the opposite ends of the body portion 60. The electrodes 52, 54 are connected to a power supply by the conductors 56, 58 which are disposed within a central bore of each leg portion 62, 64. The electrodes are typically comprised of tungsten. The conductors typically comprise niobium and molybdenum which have thermal expansion coefficients close to that of alumina to reduce thermally induced stresses on the alumina leg portion 62, 64.

The discharge chamber 50, is sealed at the ends of the leg portions 62, 64 with seals 66, 68. The seal 66, 68 typically comprise a dysprosia-alumina-silica glass that can be formed by placing a glass frit in the shape of a ring around one of the conductors, e.g., 56, aligning the discharge chamber 50 vertically and melting the frit. The melted glass then flows down into the leg 62, forming a seal between the conductor 56 and the leg 62. The discharge chamber is then turned upside down to seal the other leg 64 after being filled with the fill material.

The leg portion 62, 64, extends axially away from the centre of the discharge chamber 50. The dimensions of the leg portions 62, 64 are selected in relation to the temperature of the seal 66, 68 by desired amount with respect to the centre of the discharge chamber 50. For example, in a 70 watt lamp, the leg portions have a length of about 10-15 mm, an inner diameter of 0.8-1.0 mm and an outer diameter of about 2.5-3.0 mm to lower the temperature at the seal 66, 68 to about 600 to 700° C., which is about 400° C. less than the temperature at the centre of the discharge chamber. In a 35 watt lamp, the leg portions have a length of about 10-15 mm, an inner diameter of 0.7 to 0.8 mm and an outer diameter of about 2.0-2.5 mm. In a 150 watt lamp, the leg portions have a length of about 12-15 mm and an inner diameter of about 0.9-1.1 mm, and an outer diameter of about 2.5-3.0 mm.

The body portion 60 of the discharge chamber is typically substantially cylindrical. For a 70 watt lamp, the body portion typically has an inner diameter of about 7 mm and outer diameter of about 8.5 mm. For a 35 watt lamp, the body portion typically has an inner diameter of about 5 mm and an outer diameter of about 6.5 mm. For a 150 watt lamp, the body portion typically has an inner diameter of about 9.5 mm and an outer diameter of 11.5 mm.

An exemplary embodiment of the invention is provided in FIGS. 2A, 2B and 2C, demonstrating a discharge chamber formed from three components. FIGS. 2A-2C illustrate components of a discharge chamber formed from three elements. In FIG. 2B, a body member 122 is shown which is substantially cylindrical. The body member 122 of FIG. 2B can be formed by injection molding, die pressing, or by any other technique known in the art. For example, the body member 122 can also be formed by extrusion. The composition used may comprise, for example, 75% by weight alumina powder, 22% by weight of water soluble polyacrylamide and 3% by weight of stearate. The alumina powder may also be doped with magnesia.

The end plug 124 which forms the leg member 62, 64 in FIG. 1 is depicted which includes a leg portion 112 and a transition or head portion 114. Both the leg portion 112 and the transition portion 114 include a central bore 109 which houses one of the two electrodes and the conductor. Transition portion 114 may be generally in the form of a plug which fits inside the end of the body member 122. Transition portion 114 typically has a circumference which is greater than the circumference of the leg portion 112 and which fits into the open end of the body 122. The absence of any radially directed flange provides the advantage of the total length of the assembled discharge chamber, e.g. measured from the end 118 of leg member 120 to the opposite end 116 of end plug 124 can be maintained to within a tight dimensional tolerance. The total length of the discharge chamber typically effects the separation between the electrodes, since the electrodes are typically referenced to the ends 116, 118 of the end plugs, 120, 126 during assembly. For example, the conductor may be crimped at a fixed distance from the end of the electrode, which crimp rests against the leg portion to fix the axial position of the electrode with respect to the leg portion. Because the axial position of the electrodes is fixed with respect to the leg portions, the separation of the electrodes is determined by the position of the endplug 124 with respect to the body member 122 which can be precisely controlled thus allowing the electrodes to be consistently positioned to have a precise separation distance, which provides consistency and quality of the light produced.

The end plugs 120, 124 are constructed by die pressing a mixture of ceramic powder in a binder. Typically, the mixture comprises between about 95% by weight ceramic powder and about 5% by weight organic binder. The ceramic powder may comprise alumina (Al₂O₃) having a purity of at least 99.99% and a surface area of about 2-10 m²/g. The alumina powder will have a tap density greater than 1 g/cc. Alumina powder may be doped with magnesia to inhibit grain growth, for example in an amount equal to 0.03%-0.2%, preferably 0.05% by weight of the alumina. Accordingly, the present ceramic powder mixture and the particular ratios of the leg portion, as will be described hereafter, allow die pressing of the complex leg member shape without the leg requiring machining.

Other ceramic materials which may be used include non-reactive refractory oxides and oxynitrides such as yttrium oxide and hafnium oxide and compounds of alumina such as yttrium-alumina-garnet and aluminium oxynitride. Binders which may be used individually or in combination include organic polymers, such as polyols, polyvinyl alcohol, vinyl acetates, acrylates, cellulosics and polyesters.

Subsequent to formation, the binder is removed from the green part, typically by thermopyrollisis, to form a bisque-fired part. The thermopyrollisis may be conducted, for example, by heating the green part in air from room temperature to a maximum temperature of about 900-1100° C. over 48 hours, then holding the maximum temperature for 1-5 hours, and cooling the part. After thermopyrollisis, the porosity of the bisque-fired part is typically about 40-50%.

According to an exemplary method of bonding, the densities of the bisque-fired parts used to form the body member 122 and the end plugs 120, 124 are selected to achieve different degrees of shrinkage during the sintering step. The different densities in the bisque-fired parts may achieved by using ceramic powders having different surface areas. For example, the surface area of the ceramic powder used to form body member 122 may be 10-15 m²/g, while the surface area of the ceramic body used to form the end plugs 120 and 124 may be 2-4 m²/g. The finer powder in the body member 122 causes the bisque-fired body member 122 to have a lower density than the bisque-fired end plugs 120 and 124 made from the coarser powder. Because the bisque-fired body member is less dense than the bisque-fired leg members, the body portion shrinks to a greater degree (eg 3-10%) during sintering than the transition portion 114 to form a seal along transition portion 114.

The sintering step may be carried out by heating the bisque-fired parts in hydrogen having a dew point of about 10-15°. Typically, the furnace temperature increases from about 1000° C. to about 1300° C. over a two hour period. Next, the temperature is held to about 1300° C. for about 2 hours. Next, the temperature is increased by about 100° C. per hour up to a maximum temperature of about 1850-1880° C. Next, the temperature is held at 1850-1880° C. for about 3.5 hours. Finally, the temperature is decreased to about 1000° C. and the parts removed from the furnace. The resulting ceramic material comprises densely sintered polycrystalline alumina.

An exemplary composition which has been used for die pressing the end plugs 120, 124, comprises 95% by weight alumina powder having a surface area of 3-5 m²/g. The alumina powder is preferably spray dried and is formed via dry milling. The alumina powder is typically doped with magnesia in the amount of 0-0.05% of the weight of the alumina. The composition also includes 4% by weight polyvinyl alcohol and 1% by weight Carbowax 600.

The alumina powder or other ceramic of choice, will have a tap density greater than 1.0 gram per cc as defined by ASTM B527-93 (1997). More preferably, the tap density will be in the range of 1.2 to about 1.5 g/cc. The resultant ceramic powder composition can be die pressed according to a fill ratio of at least about 1.8.

Die pressing at approximately 10,000 pounds/inch² is typically employed.

The ability to satisfactorily press the leg members to an accuracy and smoothness such that no machining of the leg members, even at their joint with the body portion, is needed results from the use of one or more of a number of physical ratios of the dimensions of the leg portion. This enables a significant reduction in the cost of the arc tube and thus in the lamps containing these arc tubes.

While it is possible to manufacture the leg members without all of the ratios being within the ranges to be discussed below, the best results will be achieved by adhering to these.

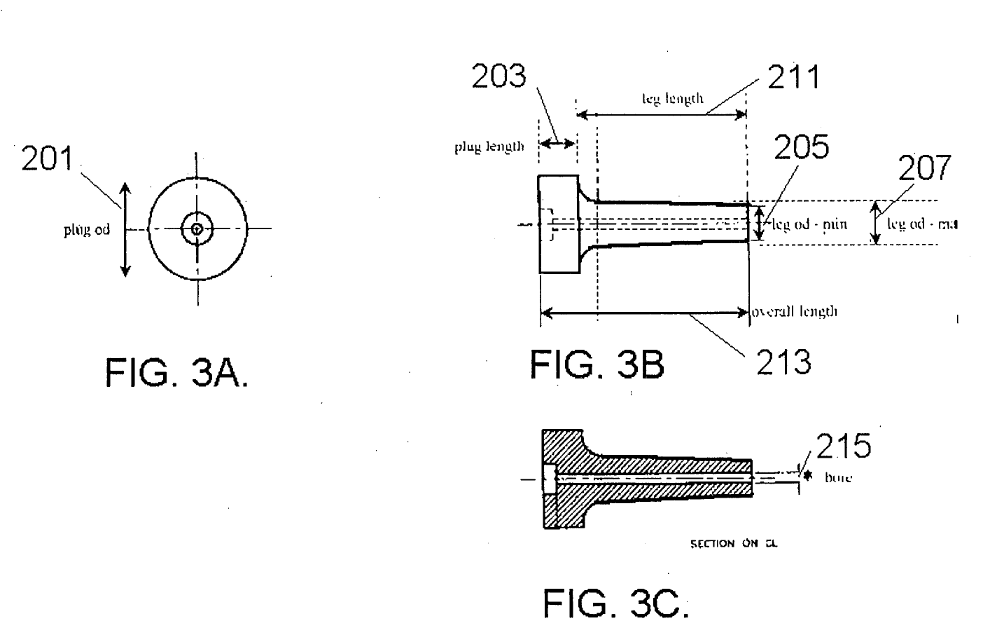

For the correct understanding of the ratios concerned, reference is made to FIGS. 3A to 3C.

FIG. 3A is an end view of the transition or plug portion of the leg member taken from the wider end and has the overall or outside diameter indicated at 201.

FIG. 3B is a side view of the leg member in which the end plug overall length is indicated at 203, the minimum leg outside diameter is indicated at 205, the maximum outside leg diameter is indicated at 207, the leg length is indicated at 211 and the overall length of the leg member is indicated at 213.

FIG. 3C is a sectional view of the leg member showing an internal bore diameter 215.

The following table sets out the various ratios used to produce the leg member of the invention.

| Ratio | Maximum Range | Preferred range |
|---|---|---|
| Overall length/minimum leg od | 5.4 to 10.7 | 6.15 to 9.72 |
| Overall length/plug od | 1.5 to 4.0 | 1.75 to 3.61 |
| Plug diameter/minimum leg diameter | 2.4 to 4.3 | 2.69 to 3.94 |
| leg length/plug length | 3.8 to 8.3 | 4.25 to 7.5 |
| leg length/overall length | 0.7 to 1.0 | 0.81 to 0.88 |
| leg aspect ratio | 3.5 to 7.3 | 3.90 to 6.66 |
| plug aspect ratio | 0.2 to 0.5 | 0.22 to 0.48 |
| plug length/overall length | 0.1 to 0.2 | 0.12 to 0.19 |
| minimum leg diameter/bore | 1.9 to 3.8 | 2.11 to 3.42 |
| taper angle per side/degrees | 0.5 to 5.0 | 1.0 to 2.0 |

1. A one piece end plug for use in a three part ceramic arc tube comprising a cylindrical head portion of a diameter suitable for insertion into a cylindrical body portion and a circular leg portion formed on the head portion so as to be coaxial therewith and tapering inwardly from the head portion outwards, the whole having a through aperture for receipt of electrodes and being formed of single ceramic pressing.

2. An end plug as claimed in claim 1, wherein the end plug is formed from approximately 95% by weight ceramic material and approximately 5% by weight organic additives.

3. An end plug as claimed in claim 2 wherein the ceramic material is 99.99% Al₂O₃.

4. An end plug as claimed in claim 3 wherein the ceramic material has added to it a metal oxide.

5. An end plug as claimed in claim 4, wherein the metal oxide is MgO in the range of 100 to 1000 ppm.

6. An end plug as claimed in claim 2 wherein the organic additives comprise a mixture of monomeric and polymeric alcohols, carbonic acids and ethers.

7. An end plug as claimed in claim 1, wherein the end plug has a ratio of overall length to minimum leg outside diameter of 5.4 to 10.7.

8. (canceled)

9. An end plug as claimed in claim 1, wherein the end plug has a ratio of overall length to plug outside diameter of 1.5 to 4.0.

10. (canceled)

11. An end plug as claimed in claim 1, wherein the end plug has a ratio of plug diameter to minimum leg diameter of 2.4 to 4.3.

12. (canceled)

13. An end plug as claimed in claim 1, wherein the end plug has a ratio of leg length to plug length of 3.8 to 8.3.

14. (canceled)

15. An end plug as claimed in claim 1, wherein the end plug has a ratio of leg length to overall diameter of 0.7 to 1.0.

16. (canceled)

17. An end plug as claimed in claim 1, wherein the end plug has a leg aspect ratio of 3.5 to 7.3.

18. (canceled)

19. An end plug as claimed in claim 1, wherein the end plug has a plug aspect ratio of 0.2 to 0.5.

20. (canceled)

21. An end plug as claimed in claim 1, wherein the end plug has a ratio of plug length to overall length of 0.1 to 0.2.

22. (canceled)

23. An end plug as claimed in claim 1, wherein the end plug has a ratio of minimum leg diameter to bore of 1.9 to 3.8.

24. (canceled)

25. An end plug as claimed in claim 1, wherein the end plug has a ratio of taper angle per side to degrees of 0.5 to 5.0.

26. (canceled)

27. A method of making a one piece end plug for use in a three part ceramic arc tube comprising pressing a single blank to form a cylindrical head portion of a diameter suitable for insertion into a cylindrical body portion and a circular leg portion formed on the head portion so as to be coaxial therewith and tapering inwardly from the head portion outwards, the whole having a through aperture for receipt of electrodes.

28. A method of making an end plug as claimed in claim 27, wherein the end plug is formed from approximately 95% by weight ceramic material and approximately 5% by weight organic additives.

29. A method of making an end plug as claimed in claim 28 wherein the ceramic material is 99.99% Al₂O₃.

30. A method of making an end plug as claimed in claim 29 wherein the ceramic material has added to it a metal oxide.

31. A method of making an end plug as claimed in claim 30, wherein the metal oxide is MgO in the range of 100 to 1000 ppm.

32. A method of making an end plug as claimed in claim 28 wherein the organic additives comprise a mixture of monomeric and polymeric alcohols, carbonic acids and ethers.

33. A method of making an end plug as claimed in claim 27 wherein the end plug has a ratio of overall length to minimum leg outside diameter of 5.4 to 10.7.

34. (canceled)

35. A method of making an end plug as claimed in claim 27, wherein the end plug has a ratio of overall length to plug outside diameter of 1.5 to 4.0.

36. (canceled)

37. A method of making an end plug as claimed in claim 27, wherein the end plug has a ratio of plug diameter to minimum leg diameter of 2.4 to 4.3.

38. (canceled)

39. A method of making an end plug as claimed in claim 27, wherein the end plug has a ratio of leg length to plug length of 3.8 to 8.3.

40. (canceled)

41. A method of making an end plug as claimed in claim 27, wherein the end plug has a ratio of leg length to overall length of 0.7 to 1.0.

42. (canceled)

43. A method of making an end plug as claimed in claim 27, wherein the end plug has a leg aspect ratio of 3.5 to 7.3.

44. (canceled)

45. A method of making an end plug as claimed in claim 27, wherein the end plug has a plug aspect ratio of 0.2 to 0.5.

46. (canceled)

47. A method of making an end plug as claimed in claim 27, wherein the end plug has a ratio of plug length to overall length of 0.1 to 0.2.

48. (canceled)

49. A method of making an end plug as claimed in claim 27, wherein the end plug has a ratio of minimum leg diameter to bore of 1.9 to 3.8.

50. (canceled)

51. A method of making an end plug as claimed in claim 27, wherein the end plug has a ratio of taper angle per side to degrees of 0.5 to 5.0.

52. (canceled)

53. A three piece ceramic arc tube comprising a central cylindrical body portion and two end plugs as claimed in claim 1, one located at each end of the cylindrical body portion.

54. A method of making a three piece ceramic arc tube comprising forming a cylindrical body portion; forming a pair of end plugs as claimed in claim 27 and attaching one end plug to each end of the cylindrical body portion.

55. (canceled)

56. (canceled)

57. (canceled)

58. (canceled)
